(19) United States
(12) Patent Application Publication
(10) Pub. No.: US 2026/0265596 A1
(43) Pub. Date: Sep. 10, 2026

(54) ADHESIVE COMPOSITION WITH COMPATIBILIZER

(71) Applicant: Dow Global Technologies LLC, Midland, MI (US)

(72) Inventors: Juan C. Tuberquia, Pearland, TX (US); Vikram Prasad, Midland, MI (US); Stacy L. Pesek, Pearland, TX (US); Alexia Finotello, Athens, OH (US)

(21) Appl. No.: 19/166,085

(22) PCT Filed: Aug. 31, 2024
(86) PCT No.: PCT/US2024/044926

§ 371 Date: Sep. 17, 2025

Related U.S. Application Data
(60) Provisional application No. 63/579,886, filed on Aug. 31, 2023.

(51) Int. Cl. C09J 193/04; C09J 123/06; C09J 123/26

(52) U.S. Cl. CPC C09J 193/04; C09J 123/06; C09J 123/26

(57) ABSTRACT

The present application provides adhesive compositions comprising: (A) an ethylene/alpha-olefin elastomer; (B) a rosin based tackifer; and (C) carboxylic acid-terminated polyethylene compatibilizer.

### FIELD

This application related generally to adhesive compositions comprising polyolefin elastomers and rosin ester compatibilizers.

### BACKGROUND

Hot melt adhesives (HMA) containing polyolefin elastomers have generally been formulated with compatibilizers comprising of hydrogenated tackifiers, to achieve superior adhesive performance. However, hydrogenated tackifiers are expensive to produce, and may be difficult to procure as petroleum feedstock supply tightens. An attractive alternative to hydrogenated tackifier compatibilizers are rosin-based tackifers. Rosin-based tackifiers are derived from naturally occurring hydrocarbon secretions of many plants and lower in cost than hydrogenated tackifiers. However rosin-based tackifiers are inherently incompatible with polyolefin elastomers. Therefore a need exists for new adhesive compositions which have improved compatibility between polyolefin elastomers and the rosin-based tackifier, as well as suitable adhesive performance.

### SUMMARY

The present application provides adhesive compositions comprising:
(A) an ethylene/alpha-olefin elastomer;
(B) a rosin based tackifer; and
(C) carboxylic acid-terminated polyethylene compatibilizer.

In other embodiments the adhesive compositions comprise of:
(A) an ethylene/alpha-olefin elastomer;
(B) a rosin based tackifer;
(C) carboxylic acid-terminated polyethylene compatibilizer;
(D) a functionalized ethylene/alpha-olefin elastomer; and
(E) a wax.

### BRIEF DESCRIPTION OF THE DRAWINGS

FIG. 1 provides the Cloud Point measurements of Example Formulations 1-6.

FIG. 2 provides the Cloud Point measurements of Example Formulations 7-12.

### DEFINITIONS

Unless stated to the contrary, implicit from the context, or customary in the art, all parts and percents are based on weight and all test methods are current as of the filing date of this disclosure.

Any reference to the Periodic Table of Elements is that as published by CRC Press, Inc., 1990-1991. Reference to a group of elements in this table is by the new notation for numbering groups. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art. The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

An “adhesive composition” is a mixture of components that is capable of joining substrates of interest together under an application of heat and/or pressure. A nonlimiting example of a suitable adhesive composition is a hot melt adhesive (HMA) composition. A “hot melt adhesive composition” is a mixture of components that is capable of joining substrates of interest together under the application of heat, or more typically, the application of heat and pressure.

The term “alkyl group” refers to an organic radical derived from an aliphatic hydrocarbon by deleting one hydrogen atom therefrom. An alkyl group may be a linear, branched, cyclic or a combination thereof. In an embodiment, the alkyl group is a C₁-C₂₀ alkyl group.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” as defined hereinafter. Trace amounts of impurities, for example, catalyst residues, may be incorporated into and/or within the polymer.

An “interpolymer” is a polymer prepared by the polymerization of at least two different types of monomers. The generic term interpolymer thus includes copolymers (employed to refer to polymers prepared from two different types of monomers), and polymers prepared from more than two different types of monomers.

An “olefin-based polymer” or “polyolefin” is a polymer that contains a majority amount of polymerized olefin monomer, for example, ethylene or propylene, (based on the weight of the polymer), and optionally, may contain at least one comonomer. Nonlimiting examples of an olefin-based polymer include an ethylene-based polymer and a propylene-based polymer.

An “ethylene-based polymer” or “ethylene polymer” is a polymer that contains a majority amount of polymerized ethylene based on the weight of the polymer, and, optionally, may comprise at least one comonomer. An “ethylene-based interpolymer” is an interpolymer that contains, in polymerized form, a majority amount of ethylene, based on the weight of the interpolymer, and at least one comonomer. Preferably, the ethylene-based interpolymer is a random interpolymer (i.e., comprises a random distribution of it monomeric constituents). A nonlimiting example of a suitable ethylene-based interpolymer is an ethylene plastomer/elastomer.

An “ethylene/alpha-olefin interpolymer” is an interpolymer that contains a majority amount of polymerized ethylene, based on the weight of the interpolymer, and at least one α-olefin. An “ethylene/α-olefin copolymer” is an interpolymer that contains a majority amount of polymerized ethylene, based on the weight of the copolymer, and an α-olefin, as the only two monomer types.

“Ethylene/alpha-olefin elastomer” is a substantially linear, or linear, ethylene/α-olefin interpolymer containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. Ethylene/alpha-olefin elastomers have a density from 0.870 g/cc, or 0.880 g/cc, or 0.890 g/cc to 0.900 g/cc, or 0.902 g/cc, or 0.904 g/cc, or 0.909 g/cc, or 0.910 g/cc, or 0.917 g/cc. Nonlimiting examples of ethylene/alpha-olefin elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available LG Chem Ltd.).

The term “heteroatom” refers to an atom other than carbon or hydrogen. Nonlimiting examples of suitable heteroatoms include: F, Cl, Br, N, O, P, B, S, Si, Sb, Al, Sn, As, Se and Ge. The terms, “hydrocarbyl” and “hydrocarbon” refer to substituents containing only hydrogen and carbon atoms, including branched or unbranched, saturated or unsaturated, cyclic, polycyclic or noncyclic species. Nonlimiting examples include alkyl-, cycloalkyl-, alkenyl-, alkadienyl-, cycloalkenyl-, cycloalkadienyl-, aryl-, and alkynyl-groups.

The term “fully hydrogenated,” as used herein, refers to a hydrogenation level greater than 90%. The term “partially hydrogenated,” as used herein, refers to a hydrogenation level from 50% to 90%. The term “non-hydrogenated,” as used herein, refers to a hydrogenation level less than 50%. The hydrogenation level can be determined by those skilled in the art, for example, by proton (1H) NMR.

### BRIEF DESCRIPTION OF THE FIGURES

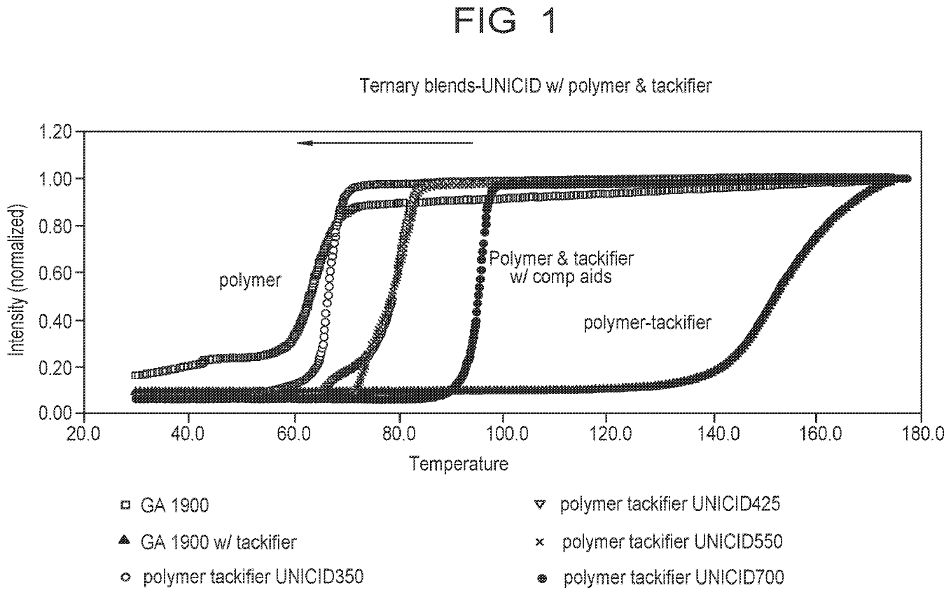

FIG. 1 Provides the Cloud Point Values for Adhesive Composition Blends 1-6.

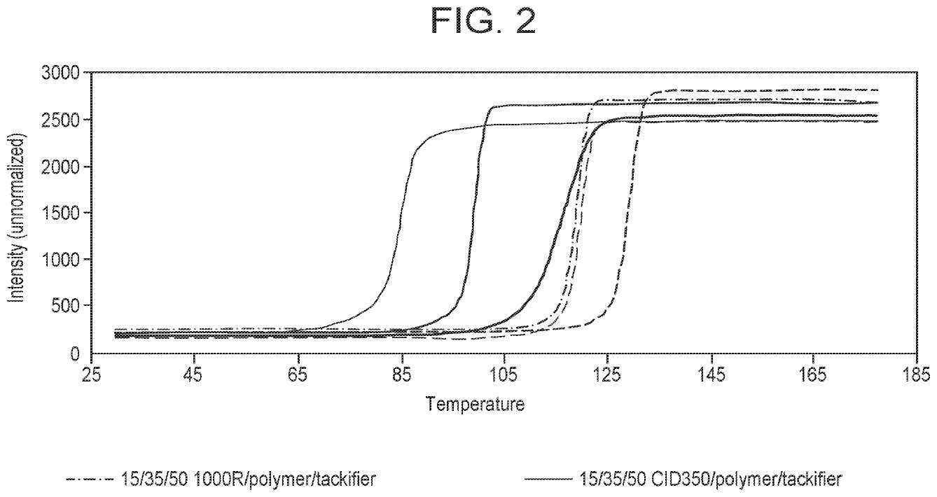

FIG. 2 Provides the Cloud Point Values for Adhesive Composition Blends 7-12.

### DETAILED DESCRIPTION

There is a strong desire among adhesive formulators and suppliers to provide end users with sustainably sourced ingredients. Rosin ester based tackifiers have a lower carbon footprint that traditional hydrocarbon based tackfiers. However, polyolefins, such as ethylene/alpha-olefin elastomers, are inherently not compatible with rosin ester based tackifiers, but do have good compatibility with hydrogenated hydrocarbon tackifiers. Applicants have surprisingly found that a specific combination of ingredients which combine rosin ester tackifiers, a carboxylic acid-terminated polyethylene compatibilizer with ethylene/alpha-olefin elastomer, shows a significant improvement in the compatibility of blends.

Accordingly, the present application provide adhesive compositions comprising of:
(A) an ethylene/alpha-olefin elastomer;
(B) a rosin based tackifer; and
(C) carboxylic acid-terminated polyethylene compatibilizer
   Further embodiments of the present application provide adhesive compositions comprising of:
(A) an ethylene/alpha-olefin elastomer;
(B) a rosin based tackifer;
(C) a carboxylic acid-terminated polyethylene compatibilizer; and
(D) a functionalized ethylene/alpha-olefin copolymer.
   Additional embodiments of the present application provide adhesive compositions further compromising of (E) an anti-oxidant.

### Component A: Ethylene Alpha-Olefin Elastomer

In one embodiment, the composition further comprises component A an ethylene/alpha-olefin elastomer. In one embodiment the ethylene/alpha-olefin elastomer is an ethylene/alpha-olefin interpolymer, and further an ethylene/alpha-olefin copolymer. Preferred alpha-olefins include, but are not limited to, C₃-C₂₀ alpha-olefins, and preferably C₃-C₁₀ alpha-olefins. More preferred alpha-olefins include propylene, 1-butene, 1-pentene, 1-hexene, 1-heptene and 1-octene, and more preferably include propylene, 1-butene, 1-hexene and 1-octene.

In one embodiment, the ethylene/alpha-olefin elastomer, of component A, has a melt viscosity less than, or equal to, 40,000 cP, further less than, or equal to, 30,000 cP, further less than, or equal to, 20,000 cP, and further less than, or equal to, 10,000 cP, at 350° F. (177° C.).

In one embodiment, ethylene/alpha-olefin elastomer, of component A, has a melt viscosity greater than, or equal to, 2,000 cP, further greater than, or equal to, 3,000 cP, further greater than, or equal to, 4,000 cP, and further greater than, or equal to, 5,000 cP, at 350° F. (177° C.). In one embodiment, the ethylene/alpha-olefin elastomer of component A, has a melt viscosity from 2,000 cP to 40,000 cP, further from 3,000 cP to 30,000 cP, further from 4,000 cP to 20,000 cP, at 350° F. (177° C.), and further from 5,000 cP to 10,000 cP, at 350° F. (177° C.).

In one embodiment, the ethylene/alpha-olefin elastomer of component A, has a molecular weight distribution (Mw/Mn) less than, or equal to, 3.5, further less than, or equal to, 3.0, further less than, or equal to, 2.5, and further less than, or equal to, 2.3. In a further embodiment, the ethylene/alpha-olefin elastomer of component A, has a molecular weight distribution (Mw/Mn) greater than, or equal to, 1.1, further greater than, or equal to, 1.3, further greater than, or equal to, 1.5, and further greater than, or equal to, 1.7.

In one embodiment, the ethylene/alpha-olefin elastomer of component A, has a weight average molecular weight distribution (Mw) less than, or equal to, 40,000 g/mole, further less than, or equal to, 30,000 g/mole, further less than, or equal to, 25,000 g/mole. In one embodiment, the ethylene/alpha-olefin elastomer of component A, has a weight average molecular weight distribution (Mw) greater than, or equal to, 2000 g/mole, further greater than, or equal to, 3000 g/mole, further greater than, or equal to, 4000 g/mole.

In one embodiment, the ethylene/alpha-olefin elastomer of component A, has a melt index (I2 or MI), or calculated melt index (I2 or MI), greater than, or equal to, 400 g/10 min, further greater than, or equal to, 600 g/10 min, or greater than, or equal to, 800 g/10 min. In one embodiment, the ethylene/alpha-olefin elastomer of component A, has a melt index (I2 or MI), or calculated melt index (I2 or MI), less than, or equal to, 2000 g/10 min, further less than, or equal to, 1500 g/10 min, and further less than, or equal to, 1200 g/10 min.

In one embodiment, the ethylene/alpha-olefin elastomer of component A, has a percent crystallinity of less than, or equal to, 40 percent, further less than, or equal to, 30 percent, and further less than, or equal to, 20 percent, as determined by DSC. In one embodiment, the ethylene/alpha-olefin elastomer of component A, has a percent crystallinity of greater than, or equal to, 2 percent, further greater than, or equal to, 5 percent, and further greater than, or equal to, 10 percent, as determined by DSC.

In one embodiment, the ethylene/alpha-olefin elastomer of component A, has a density greater than, or equal to, 0.855 g/cc, further greater than, or equal to, 0.860 g/cc, add further greater than, or equal to, 0.865 g/cc. In one embodiment, the ethylene/alpha-olefin elastomer of component A, has a density less than, or equal to, 0.900 g/cc, further less than, or equal to, 0.895 g/cc, further less than, or equal to, 0.890 g/cc, and further less than, or equal to, 0.885 g/cc. In one embodiment, the ethylene/alpha-olefin elastomer of component A, has a density from 0.855 g/cm³ to 0.900 g/cm³, further from 0.860 g/cm³ to 0.895 g/cm³, and further from 0.865 g/cm³ to 0.890 g/cm³.

In one embodiment, the ethylene/α-olefin elastomer of component A is a homogeneously branched linear interpolymer, and further a copolymer, or a homogeneous branched substantially linear interpolymer, and further a copolymer.

Some examples of ethylene/alpha-olefin elastomers include AFFINITY™ GA Polyolefin Plastomers, available from The Dow Chemical Company, and LICOCENE™ Performance Polymers from Clariant. Some examples of preferred ethylene/alpha-olefin copolymers include AFFINITY™ GA 1900, AFFINITY™ GA 1950, and AFFINITY™ GA 1875, all available from The Dow Chemical Company. Other examples of ethylene/alpha-olefin interpolymers, suitable for the invention, include the ultra low molecular weight ethylene polymers described in U.S. Pat. Nos. 6,335,410, 6,054,544 and 6,723,810, each fully incorporated herein by reference.

### Component B: Rosin Tackifier

In some embodiments, the composition includes a rosin ester. A “rosin” is a hydrocarbon secretion of many plants, particularly coniferous trees such as Pinus palustris and Pinus caribaea. Natural rosin typically consists of a mixture of seven or eight rosin acids, and other minor components. Rosin is commercially available and can be obtained from pine trees by distillation of oleoresin (gum rosin being the residue of distillation), by extraction of pine stumps (wood rosin) or by fractionation of tall oil (tall oil rosin). A rosin is generally a mixture of rosin acids, which are carboxylic acids. These naturally occurring rosins may be suitably mixtures and/or isomers of monocarboxylic tricyclic rosin acids usually containing about 20 carbon atoms. The tricyclic rosin acids differ mainly in the position of the double bonds. The rosin acid may be at least one of levopimaric acid, neoabietic acid, palustric acid, abietic acid, dehydroabietic acid, seco-dehydroabietic acid, tetrahydroabietic acid, dihydroabietic acid, pimaric acid, paulstric acid, and isopimaric acid, or mixtures, isomers, and/or derivatives thereof. Non-limiting examples of suitable rosins include gum rosin, wood rosin, tall oil rosin, and combinations thereof.

In some embodiments the rosin tackifier include rosin esters (which generally are relatively more hydrophobic, and are generally more soluble in hydrocarbons), including methyl esters of rosin, glycerol esters of rosin, triethylene glycol esters of rosin, and pentaerythritol esters of rosin, optionally any of said rosins being hydrogenated before or after derivatization (e.g. esterification). Examples of specific rosin esters tackifiers include FORAL™ 105-E, FORALYN™ 90, FORALYN™ 110, FORAL-AX-E™, PERMALYN™ 6110 available form the Eastman Chemical Company and KTP 95™ available from Komotac.

In some embodiments, a rosin tackifier refers to a polymer containing, in polymerized form, rosin and, optionally, one or more dienes, which polymeric structure is then esterified with one or more polyols, and then the esterified polymeric structure is optionally hydrogenated. It is understood that as an ester, the rosin ester contains at least one ester group with oxygen atoms, the rosin ester thereby excluding tackifier composed only of hydrogen and carbon atoms. A “polyol” is an alcohol containing at least two hydroxyl groups (—OH). A “diene” is an unsaturated hydrocarbon containing two double bonds between carbon atoms. The diene can be conjugated-, non-conjugated-, straight chain-, branched chain- or cyclic-hydrocarbon diene having from 6 to 15 carbon atoms. Nonlimiting examples of suitable diene include 1,4-hexadiene; 1,6-octadiene; 1,7-octadiene; 1,9-decadiene; branched chain acyclic diene, such as 5-methyl-1,4-hexadiene, 3,7-dimethyl-1,6-octadiene, 3,7-dimethyl-1,7-octadiene and mixed isomers of dihydromyricene and dihydroocinene; single ring alicyclic dienes, such as 1,3-cyclopentadiene, 1,4-cyclohexadiene, 1,5-cyclooctadiene and 1,5-cyclododecadiene; and multi-ring alicyclic fused and bridged ring dienes, such as tetrahydroindene, methyl tetrahydroindene, dicyclopentadiene, and bicyclo-(2,2,1)-hepta-2,5-diene; alkenyl, alkylidene, cycloalkenyl and cycloalkylidene norbornenes, such as 5-methylene-2-norbornene (MNB), 5-propenyl-2-norbornene, 5-isopropylidene-2-norbornene, 5-(4-cyclopentenyl)-2-norbornene, 5-cyclohexylidene-2-norbornene, 5-vinyl-2-norbornene, norbornadiene, 5-ethylidene-2-norbornene (ENB), 5-vinylidene-2-norbornene (VNB), 5-methylene-2-norbornene (MNB), dicyclopentadiene (DCPD); and combinations thereof. Further nonlimiting examples of suitable diene include 4-methyl-1,4-hexadiene, 7-methyl-1,6-octadiene, 5,7-dimethyl-1,6-octadiene, 3,7,11-trimethyl-1,6,10-octatriene, 6-methyl-1,5-heptadiene, 1,3-butadiene, 1,6-heptadiene, 1,8-nonadiene, 1,9-decadiene, 1,10-undecadiene, 1,5-cyclododecadiene, bicyclo[2.2.1]hepta-2,5-diene (norbornadiene), tetracyclododecene, butadiene, dicyclopentadiene, vinyl norbornene, mixed isomers of dihydromyricene and dihydroocinene, tetrahydroindene, methyl tetrahydroindene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene, and combinations thereof. In an embodiment, the diene is DCPD.

Rosin acids derived from natural sources also include rosins, i.e. rosin mixtures, modified notably by polymerisation, isomerisation, disproportionation and hydrogenation. The rosin acids may include those mentioned in U.S. Pat. Nos. 6,900,274; 6,875,842; 6,846,941; 6,344,573; 6,414,111; 4,519,952; and 6,623,554. In some embodiments, the rosin is tall rosin which is an isomeric mixture primarily composed of C₂₀ fused-ring, monocarboxylic acid hydrocarbons typified by levopimaric and abietic acids. Any type of rosin may be used, including tall oil rosin, gum rosin and wood rosin. Examples of suitable commercially available rosins include tall oil rosins such as SYLVALITE™ 2200, SYLVAROS® 85, SYLVAROS® 90 or SYLVAROS® 95 from Kranton Chemical.

### Component C: Carboxylic Acid-Terminated Polyethylene Compatibilizer

The present composition includes a carboxylic acid-terminated polyethylene compatibilizer or component C. Suitable examples of carboxylic acid-terminated polyethylene compatibilizer that may be functionalized with curable groups include a mixture of carbon chains having the structure CH₃—(CH₂)ₙ—COOH, where there is a mixture of chain length, n is from about 16 to about 50, or a linear low molecular weight polyethylene of similar average chain length. Suitable examples of such carboxylic acid-terminated polyethylene compatibilizer waxes sold by Nurcera under the tradename UNCID. Suitably examples of such carboxylic acid-terminated polyethylene compatibilizers include UNICID® 350, UNICID® 425, UNICID® 550 and UNICID® 700, wherein Mn is approximately 390, 475, 565 and 720 g/mol respectively.

Other suitable compatibilizer waxes have the structure CH₃—(CH₂)ₙ—COOH, such as hexadecanoic or palmitic acid with n=14, heptadecanoic or margaric or daturic acid with n=15, n=16 Phosphorus octadecanoic or stearic acid, icosanoic or araxic acid with n=18, docoxic or behenic acid with n=20, tetrachoanoic or lignoceric acid with n=22, hexacoic acid or cereroic acid with n=24 tonic acid, heptaconic acid or carboceric acid, n=25, octacoic acid or montanic acid, n=26, triaconic acid or melisic acid, n=28, dotriacontanic acid or laxeroic acid, n=30; tritriacontanoic acid or seomellic acid or psylic acid with n=31, tetratriacontanic acid or gedic acid with n=32, pentatriacontanic acid or celloplastic acid with n=33.

In order to approach the choice of additive in a rational manner, Applicants considered an analogy with the use of surfactants in oil-water systems in order to stabilize interfaces (such as those formed, for instance, in emulsions). For surfactants in an oil-water system, the critical parameter to consider is the so-called Hydrophobic Lipophilic Balance (HLB), which quantifies its hydrophilicity or lipophilicity (higher the HLB, higher its hydrophilicity). A simple expression of the HLB for nonionic surfactants is given by Griffin's method:

$$HLB = 20 * {M}_{h} / M \qquad Formula ( I )$$

where Mₕ and M are the molecular weights of the hydrophilic part and the entire molecule.

Within this paradigm, the effective HLB of the UNICID™ carboxylic acid-terminated polyethylene compatibilizers could then be calculated by the ratio of the molecular weight of the —COOH functional group (polar part) to the molecular weight of the entire UNICID™ molecule. The HLB values of the additives can then be correlated to their cloud points and how well it works as a compatibilizer for the tackifier and the elastomer polymer.

### Component D: Functionalized Ethylene Alpha-Olefin Copolymer

In certain embodiments, the adhesive composition further comprises component D an anhydride and/or carboxylic acid functionalized ethylene/alpha-olefin copolymer. In some embodiments component D further comprises an anhydride and/or carboxylic acid grafted ethylene/alpha-olefin copolymer. Preferred alpha-olefins include, but are not limited to, C₃-C₂₀ alpha-olefins, and preferably C₃-C₁₀ alpha-olefins. More preferred alpha-olefins include propylene, 1-butene, 1-pentene, 1-hexene, 1-heptene and 1-octene, and more preferably include propylene, 1-butene, 1-hexene and 1-octene.

In one embodiment, the anhydride and/or carboxylic acid functionalized ethylene/alpha-olefin interpolymer of component D has a density greater than, or equal to, 0.857 g/cc, further greater than, or equal to, 0.860 g/cc, add further greater than, or equal to, 0.865 g/cc. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a density less than, or equal to, 0.892 g/cc, further less than, or equal to, 0.890 g/cc, and further less than, or equal to, 0.885 g/cc. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a density from 0.855 g/cc to 0.890 g/cc, further from 0.855 g/cc to 0.885 g/cc, and further from 0.855 g/cc to 0.880 g/cc. In a further embodiment, the anhydride and/or carboxylic acid functionalized ethylene/alpha-olefin interpolymer is an anhydride and/or carboxylic acid functionalized ethylene/alpha-olefin copolymer. In one embodiment, the anhydride and/or carboxylic acid functionalized ethylene/alpha-olefin interpolymer of component D has a density from 0.857 g/cc to 0.892 g/cc, further from 0.860 g/cc to 0.890 g/cc, and further from 0.865 g/cc to 0.885 g/cc. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D comprises greater than, or equal to, 0.5 weight percent, further greater than, or equal to, 0.7 weight percent, further greater than, or equal to, 0.9 weight percent, of the anhydride and/or carboxylic acid functionality, based on the weight of the polymer. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D comprises from 0.9 to 1.5 weight percent, further from 0.9 to 1.4 weight percent, further from 0.9 to 1.3 weight percent of the anhydride and/or carboxylic acid functionality, based on the weight of the polymer. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a melt viscosity less than, or equal to, 40,000 cP, further less than, or equal to, 30,000 cP, further less than, or equal to, 20,000 cP, and further less than, or equal to, 15,000 cP, at 350° F. (177° C.). In a further embodiment, the anhydride and/or carboxylic acid functionalized ethylene/alpha-olefin interpolymer is an anhydride and/or carboxylic acid functionalized ethylene/alpha-olefin copolymer.

In one embodiment, anhydride and/or carboxylic acid functionalized ethylene/alpha-olefin interpolymer of component D has a melt viscosity greater than, or equal to, 2,000 cP, further greater than, or equal to, 3,000 cP, further greater than, or equal to, 4,000 cP, and further greater than, or equal to, 5,000 cP, at 350° F. (177° C.). In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a melt viscosity from 2,000 cP to 50,000 cP, further from 3,000 cP to 40,000 cP, further from 4,000 cP to 30,000 cP, at 350° F. (177° C.), and further from 5,000 cP to 20,000 cP, at 350° F. (177° C.). In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a molecular weight distribution (Mw/Mn) less than, or equal to, 5.0, further less than, or equal to, 4.0, further less than, or equal to, 3.0. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a molecular weight distribution (Mw/Mn) greater than, or equal to, 1.5, further greater than, or equal to, 2.0, and further greater than, or equal to, 2.5. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a molecular weight distribution (MWD) from 1.5 to 5.0, further from 2.0 to 4.0, further from 2.2 to 3.0. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a weight average molecular weight (Mw) less than, or equal to, 50,000 g/mole, further less than, or equal to, 40,000 g/mole, further less than, or equal to, 30,000 g/mole. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a weight average molecular weight (Mw) greater than, or equal to, 2000 g/mole, further greater than, or equal to, 3000 g/mole, further greater than, or equal to, 4000 g/mole. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a melt index (I2), or calculated melt index (I2), greater than, or equal to, 300 g/10 min, further greater than, or equal to, 400 g/10 min, or greater than, or equal to, 500 g/10 min. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a melt index (I2), or calculated melt index (I2), less than, or equal to, 1500 g/10 min, further less than, or equal to, 1200 g/10 min, or less than, or equal to, 1000 g/10 min. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a percent crystallinity of less than, or equal to, 40 percent, further less than, or equal to, 35 percent, further less than, or equal to, 30 percent, further less than, or equal to, 25 percent, and further less than, or equal to, 20 percent, as determined by DSC. In a further embodiment, the anhydride and/or carboxylic acid functionalized ethylene/alpha-olefin interpolymer is an anhydride and/or carboxylic acid functionalized ethylene/alpha-olefin copolymer.

In one embodiment, the anhydride and/or carboxylic acid functionalized ethylene/alpha-olefin interpolymer of component D has a percent crystallinity of greater than, or equal to, 2 percent, further greater than, or equal to, 5 percent, and further greater than, or equal to, 10 percent, as determined by DSC. In a further embodiment, the anhydride and/or carboxylic acid functionalized ethylene/alpha-olefin interpolymer is an anhydride and/or carboxylic acid functionalized ethylene/alpha-olefin copolymer.

Suitable functionalized copolymers include MAH-grafted copolymers (for example, AFFINITY™ GA 1000R Polyolefin Plastomers, available from The Dow Chemical Company).

### Other Additives

The inventive compositions may further comprise a wax. Waxes include, but are not limited to, paraffin waxes, microcrystalline waxes, high density, low molecular weight polyethylene waxes, polypropylene waxes, thermally degraded waxes, by-product polyethylene waxes, Fischer-Tropsch waxes, oxidized Fischer-Tropsch waxes, and functionalized waxes, such as hydroxy stearamide waxes and fatty amide waxes. It is common in the art to use the terminology “synthetic high melting point waxes” to include high density, low molecular weight polyethylene waxes, by-product polyethylene waxes and Fischer-Tropsch waxes.

Typically, compositions used in the invention are treated with one or more stabilizers, for example, antioxidants, such as, for example, IRGANOX™ 1010, IRGANOX™ 1076, and IRGAFOS™ 168, supplied by BASF. Compositions are typically treated with one or more stabilizers before an extrusion or other melt processes.

Other additives include, but are not limited to, ultraviolet light absorbers, antistatic agents, pigments and dyes, nucleating agents, fillers, slip agents, fire retardants, plasticizers, processing aids, lubricants, stabilizers, smoke inhibitors, viscosity control agents and anti-blocking agents. The inventive compositions may also contain one or more thermoplastic polymers. In one embodiment, the composition comprises from 0.2 to 20 weight percent, and further from 0.10 to 10 weight percent, and further from 0.5 to 5 weight percent of an additive, based on the weight of the composition.

The inventive compositions may further comprise an oil. Oils are typically employed to reduce the viscosity of the adhesive. When employed, oils will be typically present in an amount less than 50 weight percent, preferably less than 20 weight percent, and more preferably less than 10 weight percent, based on the weight of the composition. Exemplary classes of oils include, but are not limited to, white mineral oil (such as KAYDOL™ oil available from Witco), and SHELLFLEX™ 371 naphthenic oil (available from Shell Oil Company) and CALSOL™ 5550 (napthenic oil from Calumet Lubricants).

### Applications

The inventive compositions may be prepared by standard melt blending procedures. In particular, the ethylene-alpha olefin polymer or blend, tackifier(s) and other components may be melt blended, until a homogeneous mix is obtained. Any mixing method producing a homogeneous blend, without degrading the adhesive components, is satisfactory, such as a vessel equipped with a stirrer, and an optional heating mechanism. The adhesives can be provided in forms, such as pellets, pillows, chiclets, drags, or any other desired configurations.

The inventive compositions may also be used in a variety of application, including, but not limited to, case and carton sealing, automotive, graphic arts, nonwovens, panel assembly, high performance tapes, contact hot melt adhesives, paperboard coatings, inks, personal care and cosmetic products, sealants, color and additive concentrates, carpet-tape adhesives, woodworking adhesives, and profile wrap adhesives.

### Composition Blends

The following includes a non-limiting list of some embodiments of the present application.

Embodiments of the present invention may a combination of embodiments described here.

In one embodiment the adhesive composition comprises of:
(A) from 50 to 75 wt % of an ethylene/alpha-olefin elastomer;
(B) from 10 to 75 wt % of a rosin tackifier; and
(C) from 10 to 75 wt % of a carboxylic acid-terminated polyethylene compatibilizer.

In one embodiment the adhesive composition comprises of:
(A) from 20 to 50 wt % of an ethylene/alpha-olefin elastomer;
(B) from 15 to 30 wt % of a rosin tackifier; and
(C) from 15 to 30 wt % of a carboxylic acid-terminated polyethylene compatibilizer.

In one embodiment the adhesive composition comprises of:
(A) from 50 to 90 wt % of a ethylene/alpha-olefin elastomer;
(B) from 10 to 30 wt % of a rosin tackifier; and
(C) from 10 to 30 wt % of a carboxylic acid-terminated polyethylene compatibilizer.

In one embodiment the adhesive composition further comprises of: (D) a functionalized ethylene/alpha-olefin copolymer.

In one embodiment the adhesive composition comprises of:
(A) from 50 to 75 wt % of an ethylene/alpha-olefin elastomer;
(B) from 10 to 75 wt % of a rosin tackifier;
(C) from 10 to 75 wt % of a carboxylic acid-terminated polyethylene compatibilizer; and
(D) from 10 to 75 wt % of a functionalized ethylene/alpha-olefin copolymer.

In one embodiment the adhesive composition comprises of:
(A) from 20 to 50 wt % of an ethylene/alpha-olefin elastomer;
(B) from 15 to 30 wt % of a rosin tackifier;
(C) from 15 to 30 wt % of a carboxylic acid-terminated polyethylene compatibilizer; and
(D) from 15 to 30 wt % of a functionalized ethylene/alpha-olefin copolymer.

In one embodiment the adhesive composition comprises of:
(A) from 50 to 90 wt % of an ethylene/alpha-olefin elastomer;
(B) from 10 to 30 wt % of a rosin tackifier;
(C) from 10 to 30 wt % of a carboxylic acid-terminated polyethylene compatibilizer; and
(D) from 10 to 30 wt % of a functionalized ethylene/alpha-olefin copolymer.

In one embodiment the adhesive composition comprises of:
(A) from 50 to 75 wt % of an ethylene/alpha-olefin elastomer;
(B) from 10 to 75 wt % of a rosin tackifier;
(C) from 10 to 75 wt % of a carboxylic acid-terminated polyethylene compatibilizer; and
(D) from 0.25 to 2.0 wt % of an antioxidant.

In one embodiment the adhesive composition comprises of:
(A) from 50 to 75 wt % of an ethylene/alpha-olefin elastomer;
(B) from 10 to 75 wt % of a rosin tackifier;
(C) from 10 to 75 wt % of a carboxylic acid-terminated polyethylene compatibilizer;
(D) from 10 to 75 wt % of a functionalized ethylene/alpha-olefin; and
(E) from 0.25 to 2.0 wt % of an antioxidant.

In one embodiment the rosin tackifier and the carboxylic acid-terminated polyethylene compatibilizer are present in a ratio of 2:1.

In one embodiment the rosin tackifier and the carboxylic acid-terminated polyethylene compatibilizer are present in a ratio of 1:1.

In one embodiment the rosin tackifier and the carboxylic acid-terminated polyethylene compatibilizer are present in a ratio of 4:1.

In one embodiment the effective HLB of the adhesive compositions is between 1.00 and 5.00.

In one embodiment the effective HLB of the adhesive compositions is between 1.00 and 3.00.

In one embodiment the effective HLB of the adhesive composition is between 1.25 and 2.75.

In one embodiment the effective HLB of the adhesive composition is between 1.0 and 2.0

In one embodiment the carboxylic acid-terminated polyethylene compatibilizer has a Mn between 300 and 800 g/mol

In one embodiment the carboxylic acid-terminated polyethylene compatibilizer has a Mn greater than 500 g/mol.

In one embodiment the carboxylic acid-terminated polyethylene compatibilizer has a Mn less than 500 g/mol.

In one embodiment the carboxylic acid-terminated polyethylene compatibilizer has a Mn between 300 and 500 g/mol.

In one embodiment the carboxylic acid polyethylene compatibilizer has a Mₙ the is approximately 390, 475, 565 or, 720 g/mol

In one embodiment the rosin tackifier is a rosin ester tackifier.

In one embodiment the rosin tackifier is a pentaerythritol ester of hydrogenated rosin.

In one embodiment the functionalized ethylene/alpha-olefin copolymer is an anhydride and/or carboxylic acid functionalized ethylene/alpha-olefin copolymer.

In one embodiment the functionalized ethylene/alpha-olefin copolymer is a maleic anhydride functionalized ethylene/alpha-olefin copolymer.

### Test Methods

### Melt Viscosity

Melt viscosity is measured in accordance with ASTM D 3236 (350° F.), using a Brookfield Digital Viscometer (Model DV-III, version 3), and disposable aluminum sample chambers. The spindle used, in general, is a SC-31 hot-melt spindle, suitable for measuring viscosities in the range from 10 to 100,000 centipoise. The sample (polymer or adhesive composition) is poured into the chamber, which is, in turn, inserted into a Brookfield Thermosel, and locked into place. The sample chamber has a notch on the bottom that fits the bottom of the Brookfield Thermosel, to ensure that the chamber is not allowed to turn when the spindle is inserted and spinning. The sample (approximately 8-10 grams of resin) is heated to the required temperature, until the melted sample is about one inch below the top of the sample chamber. The viscometer apparatus is lowered, and the spindle submerged into the sample chamber. Lowering is continued, until the brackets on the viscometer align on the Thermosel. The viscometer is turned on, and set to operate at a shear rate, which leads to a torque reading in the range of 40 to 60 percent of the total torque capacity, based on the rpm output of the viscometer. Readings are taken every minute for about 15 minutes, or until the values stabilize, at which point, a final reading is recorded.

### Melt Index

Melt index (I2, or MI) of an ethylene-based polymer is measured in accordance with ASTM D-1238, condition 190° C./2.16 kg. For high I2 polymers (I2 greater than, or equal to, 200 g/mole, melt index is preferably calculated from Brookfield viscosity as described in U.S. Pat. Nos. 6,335,410; 6,054,544; 6,723,810. I2(190° C./2.16 kg)=3.6126[10^{(log(η)-6.6928)/-1.1363}]−9.31851, where η=melt viscosity, in cP, at 350° F. (177° C.).

### Density

Density is measured in accordance with ASTM D-792. The density measured is a “quick density,” meaning that the density is determined after one hour from the time of molding. Test samples are compression molded at a temperature of 20° C. higher than the melting point of polymer, and at a pressure of 10 MPa for five minutes (dimensions of molded sample: 50 cm²×1-2 mm).

### Cloud Point Measurement

Cloud points were measured with a custom temperature-scanning turbidity (TST) apparatus which allowed for a throughput of 13 samples per run. The overall apparatus consisted of: (a) the TST, a heated block which holds 13 vials, connected to temperature Watlow EZ-ZONE controller; (b) diffuse backlighting with a light panel and controller (Schott DCR IV, DC regulated 150 W halogen light source); (c) a digital camera to image the TST; and (d) computer for storing images and for logging data.

The TST apparatus consisted of: (a) an aluminum block with four symmetrically-distributed cartridge heaters, which had drilled recesses for 13 vials with cross-drilled holes for illumination; (b) a bolt-on aluminum cover plate with two cartridge heaters and small holes above each vial, which allowed for venting and for insertion of thermocouples to monitor temperature in the vials; (c) a ⅛″ thick copper gasket between (a) and (b) which provided head space clearance to avoid cracking of vials; (d) a glass-filled PEEK platform to which the TST was mounted, which served to effectively insulate the TST from the aluminum stand; and (e) control and overtemp thermocouples which were inserted in the TST block at middle and end locations.

Following are details of the TST method which was used to measure cloud points is provided:
1) Specimens were loaded into the block such that they do not protrude or overtighten the lid, leaving free space at the top and sides for thermal expansion.
2) Next the window guard was secured to enclosure and the camera and back light were turned on.
3) Using Qcapture, a picture is taken of the initial set-up and analyzed to ensure values were close to 4095 for an empty cell using ImageJ. At this time, the intensity and/or exposure times were adjusted until grayscale is about 200 (i.e., not fully saturated at 255). The greatest dynamic range is obtained for cloud point measurements if specimens are grouped on the basis of similar clarity.
4) Next, the TST program method was run. The following steps are performed during this program:
   a. The block was heated to an initial temperature of 180° C.; while heating, the temperature was monitored to ensure that the temperature controller was functioning properly.
   b. The program is set to equilibrate the samples at 180° C. for 5 min. If temperature logging was required, the thermocouples were carefully inserted into four specimens with care taken to ensure that the thermocouples do not extend into the imaging window. After 5 min, the T controller is switched to Ramp-Soak mode to start the cooling program. Settings for 1° C./min cooling rate are ramp end point=45° C. with a ramp duration=2:15 hr:min;
   c. In-vial temperatures and ambient temperature are logged with an 8-channel USB-TC DAQ device, K-type thermocouples, and Tracer DAQ Pro software (Measurement Computing). Readings of control and high-limit temperature controllers were recorded manually from the controller display. Sampling rate of 0.1 Hz (6 points/° C.) was sufficient because of the slow cooling rate. An acquisition duration of 165 m is preferred as it allowed for additional temperature monitoring beyond the programmed cooling ramp;
   d. Images were automatically captured with StreamPix software (NorPix) using scripting to set Δt between images and total duration for image collection; Images are captured at 30 sec intervals (only 2 images per 1° C. The total duration was set for 165 min to allow 30 min of data collection beyond the end of the T controller ramp which ends at 135 min at 45° C.;
   e. When fully cooled, vials were removed from heating block.

### EXAMPLES

The Materials used in this stud are listed in Table 1.

TABLE 1

| Material | Description | Source |
|---|---|---|
| AFFINITY ™ | Ethylene-octene copolymer | DOW |
| GA 1900 | (nonpolar polyolefin elastomer) | |
| AFFINITY ™ | Maleic anhydride grafted | DOW |
| GA 1000R | ethylene-octene copolymer | |
| UNICID ™ 425 | Additive (long chain, linear | NuCera |
| | primary carboxylic acid) | |
| UNICID ™ 350 | Additive (long chain, linear | NuCera |
| | primary carboxylic acid) | |
| UNICID ™ 550 | Additive (long chain, linear | NuCera |
| | primary carboxylic acid) | |
| UNICID ™ 700 | Additive (long chain, linear | NuCera |
| | primary carboxylic acid) | |
| Foralyn ™ 110 | Tackifier (pentaerythritol based | Eastman Chemical |
| | Rosin ester) | |
| UNILIN ™s | Additives (long chain, linear | NuCera |
| | primary alcohols) | |

Formulations for compositions in FIGS. 1 and 2 are provided in Tables 2 and 3

TABLE 2
Composition Blends shown in FIG. 1

| | | | | Carboxylic | | | |
|---|---|---|---|---|---|---|---|
| | | | Rosin | Acid | Type of | Anti- | |
| | | Elastomer | Tackifier | Terminated | Carboxylic Acid | oxidant | |
| | | AFFINITY | (wt %) | Polyethylene | Terminated | Irganox | |
| Composition | Description of | GA 1900 | Foralyn | Compatibilizer | Polyethylene | B225 | Additive HLB |
| Blend | Composition Blends | (wt %) | 110 | (wt %) | Compatibilizer | (wt %)* | (effective) |
| 1 | 100 Elastomer | 100 | 0 | 0 | | 1 | |
| 2 | 50/50 Elastomer/Rosin | 50 | 50 | | | 1 | |
| | Tackifier | | | | | | |
| 3 | 25/50/25 | 25 | 50 | 25 | UNICID 350 | 1 | 2.3 |
| | Elastomer/Rosin | | | | | | |
| | Tackifier/UNICID 350 | | | | | | |
| | Compatibilizer | | | | | | |
| 4 | 25/50/25 | 25 | 50 | 25 | UNICID 425 | 1 | 1.9 |
| | Elastomer/Rosin | | | | | | |
| | Tackifier/UNICID 425 | | | | | | |
| | Compatibilizer | | | | | | |
| 5 | 25/50/25 | 25 | 50 | 25 | UNICID 550 | 1 | 1.6 |
| | Elastomer/Rosin | | | | | | |
| | Tackifier/UNICID 550 | | | | | | |
| | Compatibilizer | | | | | | |
| 6 | 25/50/25 | 25 | 50 | 25 | UNICID 700 | 1 | 1.25 |
| | Elastomer/Rosin | | | | | | |
| | Tackifier/UNICID 700 | | | | | | |
| | Compatibilizer | | | | | | |

*Total composition is 101 wt %

TABLE 3
Blend compositions shown in FIG. 2 (blends with 1000R and UNICID 350)

| | | | Compatibilizer | | Rosin | Anti- |
|---|---|---|---|---|---|---|
| | | Compatibilizer | Additive 2 - | Elastomer | Ester | oxidant |
| | | Additive 1 - | AFFINITY | AFFINITYGA | Foralyn | Irganox |
| | | UNICID 350 | GA 1000R | 1900 | 110 | B225 |
| Composition | Description of Composition | (wt %) | (wt %) | (wt %) | (wt %) | (wt %)* |
| 7 | 15/35/50 1000R/Elastomer/Rosin Tackifier | 15 | 0 | 35 | 50 | 1 |
| 8 | 15/35/50 UNCID350/Elastomer/Rosin | 0 | 15 | 35 | 50 | 1 |
| | Tackifier | | | | | |
| 9 | 7.5/7.5/35/50 | 7.5 | 7.5 | 35 | 50 | 1 |
| | 1000R/UNCID350/Elastomer/Rosin | | | | | |
| | Tackifier | | | | | |
| 10 | 7.5/42.5/50 UNICED 350/Elastomer/Rosin | 7.5 | 0 | 42.5 | 50 | 1 |
| | Tackifier | | | | | |
| 11 | 7.5/42.5/50 1000R/Elastomer/Rosin | 0 | 7.5 | 42.5 | 50 | 1 |
| | Tackifier | | | | | |
| 12 | 3.75/3.75/42.5/50 | 3.75 | 3.75 | 42.5 | 50 | 1 |
| | 1000R/UNCID350/Elastomer/Rosin | | | | | |
| | Tackifier | | | | | |

*Total composition is 101 wt %

### Results

The Cloud Points for each of the compositions prepared in Tables 2 and 3 are reported in Tables 4 and 5 respectively.

TABLE 4
Cloud Point Results for FIG. 1

| | | TST Cloud | Additive |
|---|---|---|---|
| Composition | Description of | Point Result | effective |
| Blend | Composition Blends | (deg C.) | HLB |
| 1 | 100 Elastomer | 61.2 | N/A |
| 2 | 50/50 Elastomer/Rosin | 169.9 | N/A |
| | Tackifier | | |
| 3 | 25/50/25 Elastomer/Rosin | 70.7 | 2.3 |
| | Tackifier/UNICID 350 | | |
| | Compatibilizer | | |
| 4 | 25/50/25 Elastomer/Rosin | 83.1 | 1.9 |
| | Tackifier/UNICID 425 | | |
| | Compatibilizer | | |
| 5 | 25/50/25 Elastomer/Rosin | 84.2 | 1.6 |
| | Tackifier/UNICID 550 | | |
| | Compatibilizer | | |
| 6 | 25/50/25 Elastomer/Rosin | 97.5 | 1.25 |
| | Tackifier/UNICID 700 | | |
| | Compatibilizer | | |

TABLE 5
Cloud Point Results for FIG. 2

| Compo- | | TST Cloud |
|---|---|---|
| sition | | Point Result |
| Blend | Description of Composition | (deg C.) |
| 7 | 15/35/50 1000R/Elastomer/Rosin Tackifier | 92.9 |
| 8 | 15/35/50 UNCID350/Elastomer/Rosin | 121.2 |
| 9 | Tackifier 7.5/7.5/35/50 | 101.8 |
| | 1000R/UNCID350/Elastomer/Rosin Tackifier | |
| 10 | 7.5/42.5/50 UNICED 350/Elastomer/Rosin | 123.0 |
| | Tackifier | |
| 11 | 7.5/42.5/50 1000R/Elastomer/Rosin Tackifier | 132.1 |
| 12 | 3.75/3.75/42.5/50 | 122.3 |
| | 1000R/UNCID350/Elastomer/Rosin Tackifier | |

As shown in Table 4, there is a correlation between the effective HLB and Cloud Point. Specifically, Applicants found that the higher the effective HLB of the additive, the lower the Cloud Point was for the same weight percent additive. This is shown by the comparison of Composition Blend 3 with Composition Blends 4-6, where Composition Blend 3 has an effective HLB of 2.3 and a Cloud Point of 70.7 whereas Composition Blend 6 has an effective HLB of 1.25 and a Cloud Point of 97.5. Further as shown in Table 5, Applicants found that the carboxylic acid-terminated polyethylene compatibilizer UNICID™ 350 has a lower Cloud Point than the functionalized ethylene/alpha-olefin copolymer AFFINITY™ GA 1000R at same additive concentration. Moreover, no synergistic effect was observed when AFFINITY™ GA 1000R and UNICID™ 350 are placed together.

1. An adhesive composition comprising of:
(A) an ethylene/alpha-olefin elastomer;
(B) a rosin tackifier; and
(C) a carboxylic acid-terminated polyethylene compatibilizer.

2. The adhesive composition of claim 1 further comprising of:
(A) from 50 to 75 wt % of the ethylene/alpha-olefin elastomer;
(B) from 10 to 75 wt % of the rosin tackifier; and
(C) from 10 to 75 wt % of the carboxylic acid-terminated polyethylene compatibilizer.

3. The adhesive composition of claim 1 further comprising of: (D) a functionalized ethylene/alpha-olefin copolymer.

4. The adhesive composition of claim 1, wherein the rosin tackifer and the carboxylic acid-terminated polyethylene compatibilizer are present in a ratio of 2:1.

5. The adhesive composition of claim 1 wherein the ethylene/alpha elastomer has a density greater than, or equal to, 0.855 g/cc.

6. The adhesive composition of claim 1, wherein the effective HLB of the adhesive compositions is between 1.00 and 2.00.

7. The adhesive composition of claim 1, wherein the effective HLB of the adhesive composition is between 1.25 and 1.75.

8. The adhesive composition of claim 1, where the carboxylic acid-terminated polyethylene compatibilizer has a Mn between 300 and 800 g/mol

9. The adhesive composition of claim 8, wherein the carboxylic acid-terminated polyethylene compatibilizer has a Mn greater than 500 g/mol.

10. The adhesive composition of claim 1 wherein the rosin tackifier is a pentaerythritol ester of hydrogenated rosin.
